(19) United States
(12) Patent Application Publication
(10) Pub. No.: US 2014/0156528 A1
(43) Pub. Date: Jun. 5, 2014

(54) METHOD AND SYSTEM FOR SECURE MOBILE PAYMENT OF A VENDOR OR SERVICE PROVIDER VIA A DEMAND DRAFT

(71) Applicant: Stephen Frechette, Newton, MA (US)

(72) Inventor: Stephen Frechette, Newton, MA (US)

(21) Appl. No.: 13/832,971

(22) Filed: Mar. 15, 2013

Related U.S. Application Data
(60) Provisional application No. 61/732,272, filed on Nov. 30, 2012.

(51) Int. Cl. G06Q 20/38

(52) U.S. Cl. CPC G06Q 20/385
USPC 705/44

(57) ABSTRACT

A method and system for consumers to pay vendors or service providers is presented. A demand draft is created and sent to a vendor or service provider from a trusted third party on behalf of a consumer. The verification of consumer funds available to cover the demand draft is not necessary because the demand draft is from a trusted third party to a vendor or service provider. The method employs real-time geolocation information available within mobile devices and time-synchronized one time passwords to increase the security of the process.

### CROSS-REFERENCE TO RELATED APPLICATIONS

This application claims the benefit of U.S. Provisional Patent Application No. 61/732,272 filed on Nov. 30, 2012, which is hereby incorporated herein by reference in its entirety.

### BACKGROUND OF THE INVENTION

1. Field of the Invention

The invention is a method and process for a consumer to pay a vendor or service provider. The problem that the invention solves is as follows:

The problem is how consumers pay vendors and service providers without the use of cash, and without the need for the vendor or service provider to immediately verify that the consumer has the available funds to cover the demand draft, the electronic check, or the debit card charge.

The invention consists of a method and process for payment of a vendor or service provider via the scanning of a QR code, Quick Response Code, from a handheld device or card. A QR code is an image that is encoded with information. The invention solves the problem by requesting that the consumer a priori create an online profile on a server accessible on the Internet, which contains the consumer's bank account information or credit card information. The result of the payment from the consumer to the vendor is a wire transfer, delivery of a check, digital/electronic delivery of a demand draft or electronic check from a third party to the vendor. Since the vendor does not determine if the consumer has available funds in an account to cover the check, the vendor simply accepts a demand draft or check from a third party on behalf of the consumer. The check from the third party is made out to the vendor on behalf of the consumer, but the demand draft or check is from the third party, in the same manner that a cashier's check is guaranteed by a bank.

An inventive step of this invention is that a vendor reads the QR code provided by a consumer, which does not need to have internet access at the approximate time of purchase. Once the QR code is read, an approval process commences. If the approval process is successful a demand draft is sent on behalf of the consumer by a third party to a vendor.

The invention additionally consists of a method and process in which the consumer initiates a process in which a trusted third party creates and electronically delivers a demand draft, i.e., a remotely created check, on behalf of the consumer to the vendor or service provider. Since the vendor/service-provider trusts the third party's demand draft, and does not have to verify that funds are available, the payment method is acceptable. The method includes the step of the consumer automatically creating and approving both the creation and delivery of a demand draft, i.e., a remotely created check, from both the third party to the vendor/service-provider and from themselves to the third party. The consumer approves the creation of the demand draft with a signature, an electronic signature, or a recorded electronic acknowledgement.

2. Description of Prior Art

In prior art methods and processes for consumers to pay vendors and service providers via demand draft fall short of meeting all the needs of the consumers and vendors. In prior art common systems for payment include the use of personal computers and servers on the Internet in which a consumer fills out an online form including name, payment amount, bank routing number, bank account number, and approval signature or electronic signature/approval. Using information from the online form a demand draft is created. A demand draft is also known as a remotely created check. It is similar to a digital copy of a check but is created by a merchant or third party without the consumer's original signature.

This invention differs from the previously mentioned prior art in that the invention employs a QR code to store or transform information that is passed via a vendor or service provider to a third party, which creates the demand drafts. Additionally, the consumer who initiates the payment does not need to have access to the Internet, because their information is conveyed through the QR code to the vendor/service-provider who has Internet access.

This invention also differs from previous art including other QR code mobile payment processes in that the QR code encodes both geolocation information and time-synchronized one-time use passwords generated by a handheld device for authorization on a third party server pursuant of the creation of demand drafts.

The invention differs from previous art in that previous art requires the instant verification that the consumer/payer has funds available to pay the vender/service-provider. This invention is a method and process for the payment of a vendor or service provider that does not require the immediate verification that the consumer has funds in an account that are available to cover the demand-draft/payment. Since immediate verifications of the consumer's available funds is not necessary, a banking fee to determine an availability of funds is not incurred, thus the vendor or service provider benefits from a significant cost savings.

### BRIEF SUMMARY OF THE INVENTION

The presented invention is a method and process for the use of demand drafts as a secure mobile payment system.

Additionally, the invention differs from previous art in that it employs software that operates on a handheld device or cell phone that generates a unique password periodically, every 60 seconds. The password is a time-synchronized one-time use password generated by software on the hand-held device or personal computer or mobile device, and is verified by a matching password generated by software on a server on the Internet. The QR code contains the dynamically created time-synchronized one-time use password, the unique consumer identification, ID, geolocation, timestamp, and minimum and maximum range of an acceptable bill, which is then scanned in by the vendor/service-provider. Therefore, at the time of purchase, a digital log records the time synchronized password that was generated by the consumer's handheld device, e.g., cell phone, at the time of the sale. The geolocation of the handheld device at the time of the sale is included in the information contained within the QR code, only if that information is available at the time of the sale.

Additionally, the invention differs from previous art in that it employs an optional step of determining the location of both the consumer and vendor/service-provider at the time of the transaction to aid in security. The location could be automatically monitored by a Global Positioning System, GPS, and web-enabled cell phone, and the location reported to a server on the Internet. The geolocation information could be obtained via HTML 5 or OS specific functions provided within smart phones. The consumer who purchases the goods or service may also have a GPS (or location aware phone via IP address or radio tower triangulation) and web-enabled cell phone, and their location could also be reported to a server on the Internet at the time of the request. Both the vendor/service-provider and consumer can simply manually enter in their geolocation via a website that reports the information to a server on the Internet, and this information can be saved in an online profile.

A service provider is defined as any business or individual that provides a service to a consumer, e.g., a taxi ride, fencing job, or tutoring. A vendor is defined as any business or individual that provides a sale of an item to the consumer.

The location of the consumer or vendor/service-provider may be determined by any geographic locating means available on a cell phone or personal computer or any device capable of displaying a web page on the Internet. The means to determine the consumer or vendor/service-provider's location via a cell phone or any web-enabled device may include Global Positioning System, GPS, IP-addressed based locating method, cell-phone radio tower triangulation, or any other means available on a cell phone for determining location. The consumer's location may include not only coordinates or approximate coordinates or street address or approximate street address, but also the location in the context of a business or park name. The process for determining a label, e.g., XYZ retail store, for the location of the consumer involves third-party servers and services that are currently available to anyone working in the field of web-based computer programming.

The process and transactions adheres to the Check Clearing for the 21st Century Act, which went into effect Oct. 28, 2004. The consumer acknowledges, when signing up for the service, that upon usage of the service, a demand draft will be generated and is notified that electronic checks will be employed for payments.

At the time of payment the consumer must electronically sign and/or acknowledge by checking a box, that two demand-drafts have been generated for the payment amount, one from the third party to the vendor/service-provider and the other from themselves, the consumer, to the third party. The reason that the demand draft from the third party has been generated is because it is similar to a cashier's check, in the sense that the vendor/service-provider will trust that the funds are available from the third party. The generated document is actually not a cashier's check but rather referred to as a demand draft.

Another embodiment of the invention is a payment method for the consumer to pay the vendor/service-provider directly, without a third party acting as an intermediary. A server that is accessible via the Internet contains a profile that the consumer and vendor/service-provider create. Bank account information is to be used in the creation of a demand draft from the consumer to the vendor or service provider.

In other aspects, the invention provides a system having features and advantages corresponding to those discussed above.

### BRIEF DESCRIPTION OF THE DRAWINGS

FIG. 1 is a flow diagram that illustrates the physical steps for the payment process, in which a Consumer pays a Vendor/Service-Provider.

FIG. 2 is a flow diagram that illustrates the validation and messaging steps and various component interactions that may be performed by the process provided in FIG. 1.

FIG. 3 is a flow diagram that illustrates the dataflow necessary for a method for Consumers to pay Vendors/Service-Providers for sales or services rendered.

FIG. 4 is a high level diagram that shows parties or entities that interact with the method for Consumers to pay Vendors/Service-Providers for sales or services rendered.

FIG. 5 is an illustration of the environment that the presented invention may operate on.

FIG. 6 is a flow diagram of an exemplary method for third party approval of Consumer payment or gift certificate usage operations in a manner consistent with the present invention, illustrated in FIG. 2 255.

FIG. 7 is a flow diagram of an exemplary method for performing Consumer information entry and/or management operations in a manner consistent with the presented invention.

FIG. 8 is a diagram of an exemplary apparatus that may perform various operations in a manner consistent with the presented invention.

FIG. 9 illustrates exemplary Consumer payment and verification information that is consistent with the presented invention and noted in FIG. 2 item 243′.

FIG. 10 illustrates exemplary Vendor/Service-Provider information that is consistent with the presented invention and noted in FIG. 2 item 247′.

FIG. 11 illustrates the dataflow and communication process for an exemplary method for performing a Consumer purchase from a Vendor/Service-Provider that is consistent with the presented invention and noted in FIG. 1 and FIG. 2.

FIG. 12 is a flow diagram of an exemplary method for performing Vendor/Service-Provider information entry and/or management operations in a manner consistent with the presented invention.

FIG. 13 illustrates exemplary Consumer electronic signature information that is consistent with the presented invention and noted in FIG. 2 item 290′.

FIG. 14 illustrates exemplary Consumer information stored on a third party server that is consistent with the presented invention and noted in FIG. 2 item 257′.

FIG. 15 illustrates information necessary for the creation of a demand draft that is consistent with the presented invention and noted in FIG. 2 item 260′.

FIG. 16 illustrates information necessary for the creation of a demand draft, with the Consumer as the payer and the Third party as the payee, that is consistent with the presented invention and noted in FIG. 2 item 265′.

### DETAILED DESCRIPTION OF THE INVENTION

The presented invention may involve novel methods, apparatuses, message formats, QR codes, and/or data structures for obtaining and using geolocation information and time-synchronized one time use passwords for the creation of demand drafts from a third party to a vendor/service-provider on behalf of a consumer, and consumer to the Third party.

The uses of the invention includes but are not limited to the following scenarios:

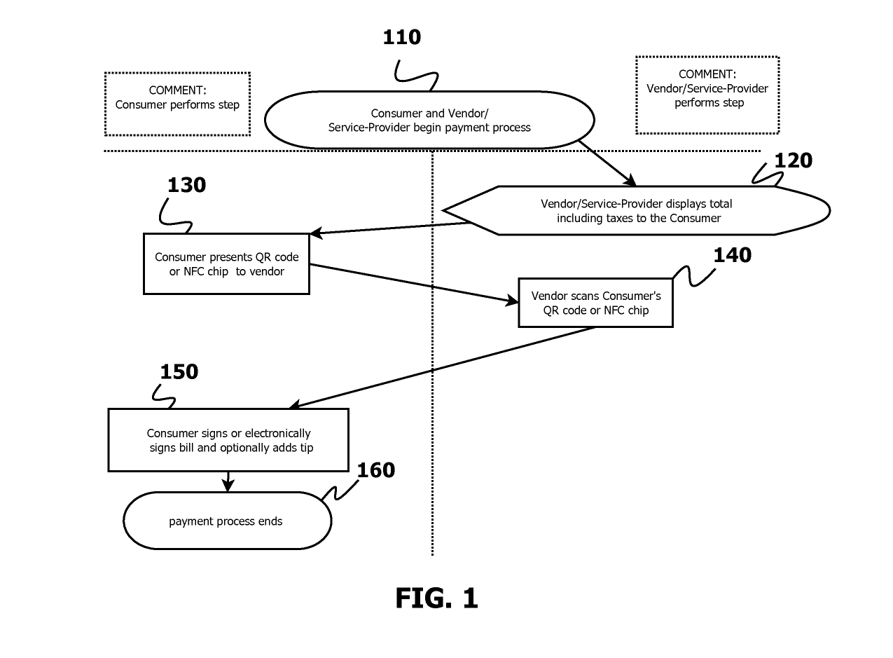

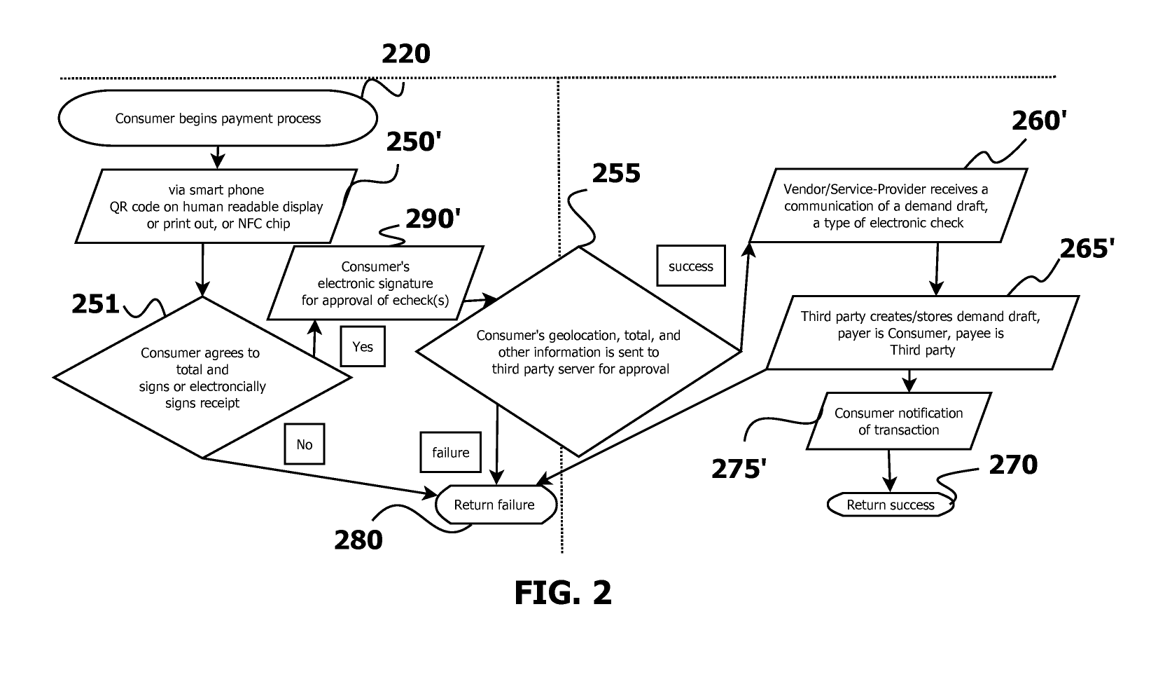

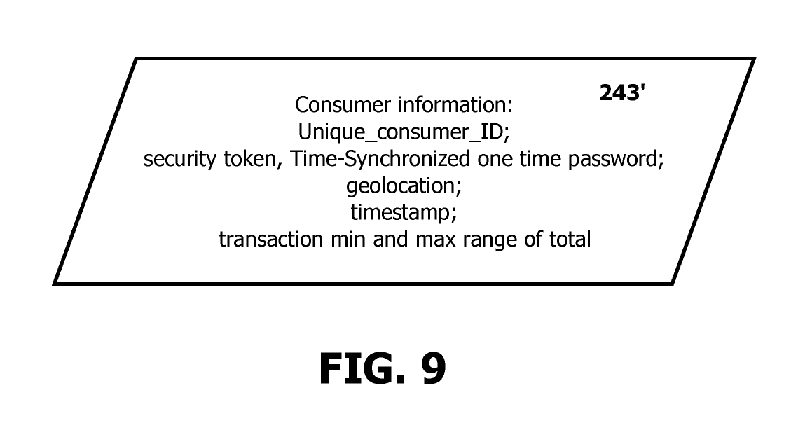

In this scenario the consumer wants to pay a vendor or service provider. The consumer uses a smartphone to generate a QR code that contains the pieces of information listed in FIG. 9 243′. The security token, i.e., authentication token, that is a time-synchronized one-time use password that is generated by software and can be verified by a server on the Internet. This scenario is detailed in FIG. 1 110. The consumer may then choose to pay the service provider using the consumer payment to service provider embodiment of the invention detailed in FIG. 2 220.

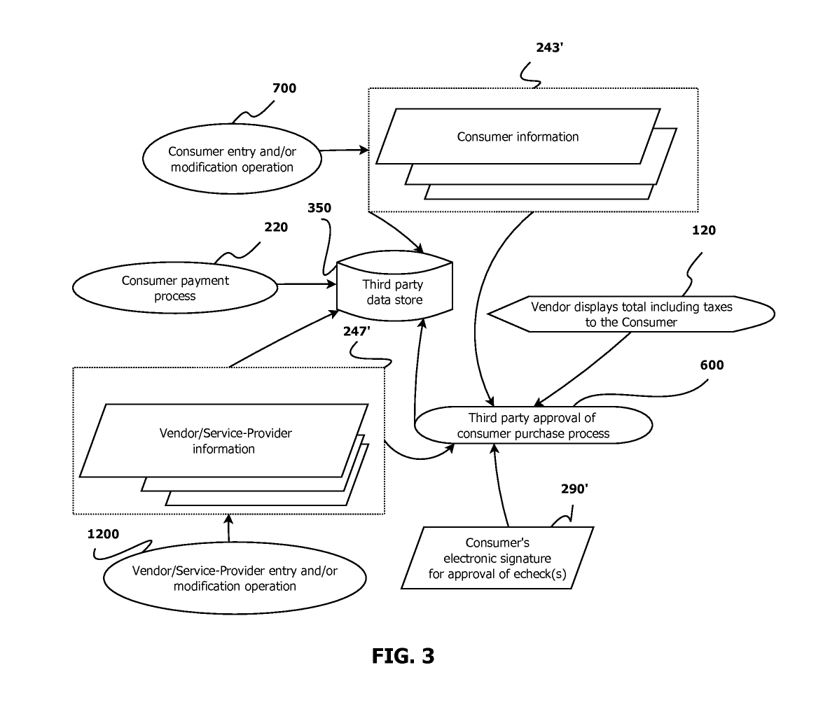

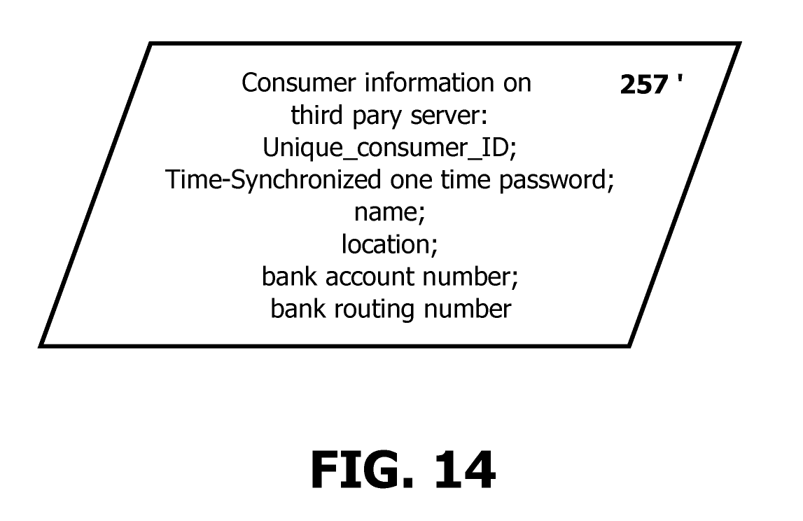

In this embodiment of the invention the QR code is encoded with a unique consumer ID that is employed to map to a data store FIG. 3 350 and contains all the information necessary to create a demand draft, FIG. 14 257′. The consumer that uses the demand draft must be displayed the total amount and be prompted by the vendor/service-provider to sign and approve the purchase. Two demand drafts are created in this system, one is from the consumer to third party, and the second demand draft is from the third party to the vender/service-provider. Since a demand draft is sent from a third party, the vendors and service-providers simply needs to verify that the consumer is in good standing with the third party, thus they do not incur banking fees. Another embodiment of the invention is the consumer's use of a gift card or prepaid account. In this embodiment a QR code is displayed in a smart phone's display screen or printed out on a card. The QR code contains the information necessary to verify that the funds are available, which includes the information listed in FIG. 9 243′.

In another embodiment of the invention the demand draft that is made out directly from the consumer to the vendor/service-provider, without the need to send demand drafts to or from a third party.

In another embodiment of the invention the QR code represents a prepaid gift card. The unique ID in the QR code refers to a pre-funded account. Rather than a unique consumer ID, funds are verified via a unique ID that represents a prepaid gift card account.

Another embodiment of the invention is the payment means via the consumer's use of a QR code in the form of a business card sized card, or paper printout, which contains the information listed in FIG. 9 243′. The geolocation, time-synchronized one time use passwords and timestamp is generated at the time of printout. In this embodiment of the invention the vendor or service-provider scans in the QR code and then displays the total amount and prompts the consumer to sign and approve the purchase. The time-synchronized one-time use passwords are generated by software on hand held device that matches password on Third party server. Counter-synchronized one-time use passwords could also be employed rather than time-synchronized one-time use passwords.

In this invention either the vendor receives an echeck or electronic payment from the consumer, or passes along the consumer's information to a third party, and then the third party transmits an echeck or electronic payment to the vendor.

FIG. 1 illustrates a method's physical steps for the payment process, in which a Consumer pays a Vendor/Service-Provider. The Consumer begins a payment process in 110 that involves standard computer machines 510, 550, and 540. A Vendor/Service-Provider displays the total including taxes to the Consumer 120. The Consumer then presents a Quick Response Code, QR code, or Near Field Communication, NFC chip 130 to the Vendor/Service-Provider. The Consumer may present the vendor a QR code via a display on a web-enabled cell-phone, personal computer, or any web-enabled device with a human readable display, which the Vendor then scans via a scanner or digital camera with or without video capabilities. The vendor uses an optical scanner/camera or NFC chip reader to read the Consumer's information 140. The Consumer is presented the total by the vendor at which time the Consumer may decide to sign, add a tip, and thus pay the bill via a signature on an electronic pad or touch screen, or check a box that represents and electronic signature and approval to pay the bill 150. The Consumer is displayed and signs the bill via a display on a web-enabled cell-phone, personal computer, or any web-enabled device with a human readable display. At this point the payment process is complete 160.

FIG. 2 illustrates the data flow necessary for a method for Consumer payment to the Vendor/Service-Provider. First, a Consumer decides to begin the payment process 220. Next a QR code is displayed on a web-enabled cell-phone, personal computer, or any web-enabled device with a human readable display or an NFC chip is read in 250′. Then the Consumer's electronic signature or electronic record of approval for payment is asked for 251 and recorded 290′. Using the Consumer's approval 290′ and information on a third party server 510, including Consumer information FIG. 3 243′ and Vendor/Service-Provider information FIG. 3 247′, a third party determines whether to approve the transaction 255. Upon approval the Vendor/Service-Provider receives a communication from the third party server 260′ of the approval or denial, via an email, SMS text message, or other electronic communication means. Next the Third party creates and stores a demand draft 265′ whose payer is the Consumer and payee is the Third party. The Vendor/Service-Provider at some future point then accepts the transaction, this step may be automated, i.e., automatic acceptance. Lastly the Consumer is notified of the successful transaction 275′ and the transaction is complete 270.

Item 255 is a validation step, and the payment will not be processed unless this test is passed. The test 255 is to determine if the Consumer is within the Service-Provider's service area as determined by a geolocation determination method on a personal computer or cell phone, which may include but is not limited to GPS, IP-addressed based locating method, cell-phone radio tower triangulation, or any other means available on a personal computer or cell phone for determining location, or a manual entry of the users' location. The communication 260′ is from a server on the internet 260′ that a payment was received, and that the Service-Provider agrees that full payment has been received and the transaction is complete 270.

FIG. 3 is a diagram that illustrates various operations that may be performed by the presented invention, and information sets that may be used and/or generated by the presented invention. Various aspects of the Consumer payment to Vendor/Service-Provider process interactions are illustrated. The Consumer entry and/or modification of operation is shown 700, which modifies Consumer information 243′. The Vendor/Service-Provider entry and/or modification operation is shown 1200 to modify the Consumer information 247′.

The total that the Vendor/Service-Provider displays to the Consumer 120 and a record of the Consumer's approval 290′ is passed to the Third party server for approval 600. Additionally Consumer 243′ and Vendor/Service-Provider 247′ information is required for the Third party approval process 600. Third party data store 350, stores the following items and/or records: Consumer information 243′, Vendor/Service-Provider information 247′, acknowledgement that both the Consumer payment process 220 and the Third party approval of the consumer purchases process have been successfully completed.

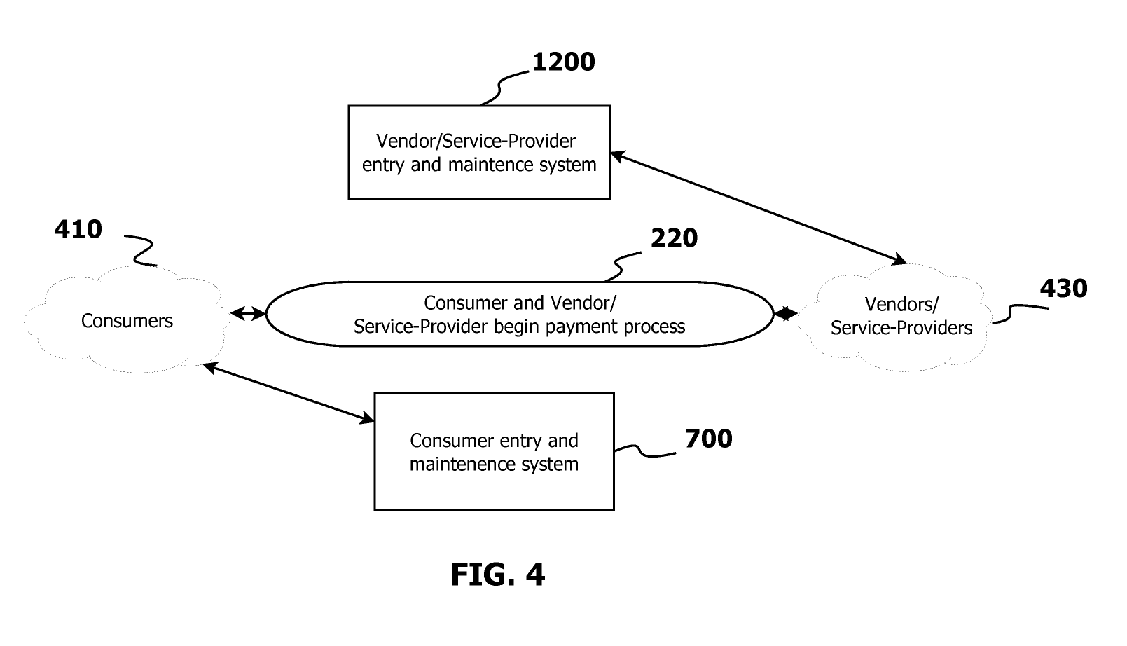

FIG. 4 is a high level diagram of a Consumer to Vendor/Service-Provider payment method's environment. The environment may include a Service-Provider entry and/or maintenance system 1200, and a Consumer entry and/or maintenance system 700. Both the Consumers 410 and Vendors/Service-Providers 430 interact during the payment process 220. Information from a third party data store 350 stores the information required for the system and process illustrated in FIG. 4.

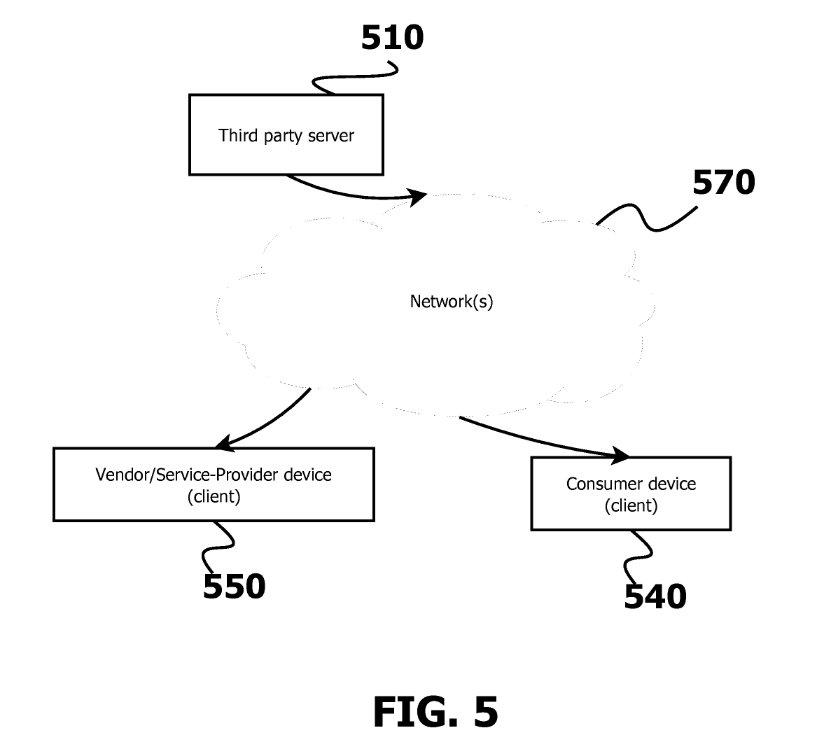

FIG. 5 illustrates an environment in which the present invention may be used. A Consumer device 540 and Service-Provider device 550 may include an Internet browser or a mobile phone application. A Third party server 510 enables the Consumer device 540 and the Vendor/Service-Provider 550 access the database and data store 350. The communication between elements is provided by the network 570.

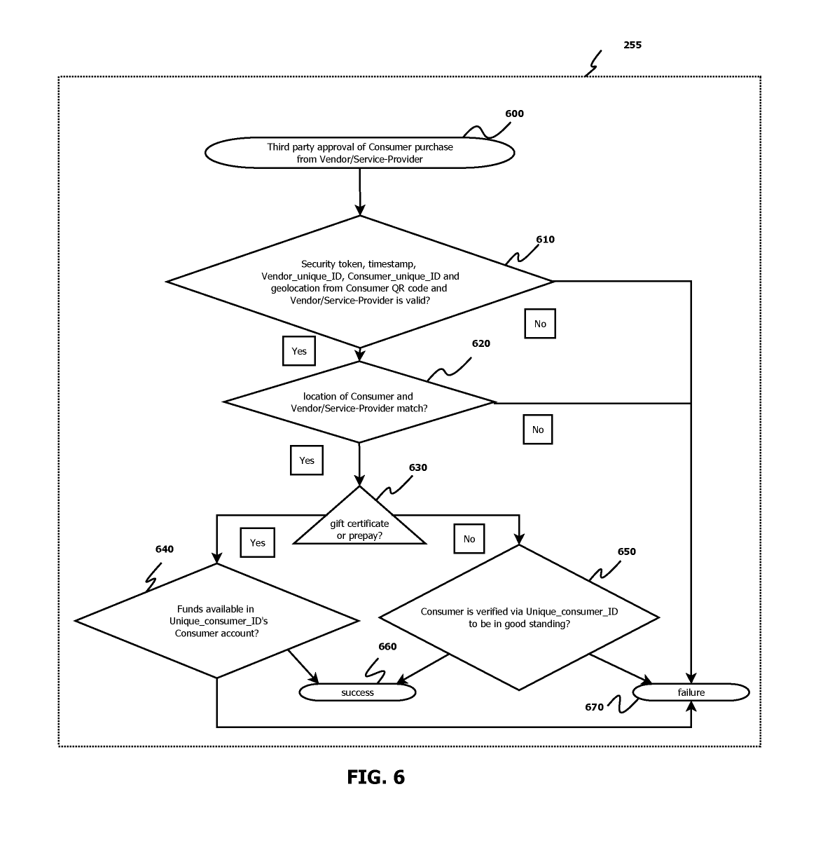

FIG. 6 is a diagram of a method and process for a Third party to approve a Consumer payment to a Vendor/Service-Provider 600. Information from the Consumer FIG. 3 243′ and the Vendor/Service-Provider FIG. 3 247′, in regards to the payment, is determined to be valid or invalid 610. The information that is used to validate the payment includes but is not limited to security tokens in the form of time-synchronized one-time use passwords, and timestamps. Next the geolocation information from both the Consumer and Vendor/Service-Provider is determined to match or not match 620. Whether the Consumer uses a gift certificate or pre-paid account is determined 630. If the answer is yes then the funds in the account are determined to be available to cover the charge 640, and payment validation is returned as a success 660, else failure is returned 670. If a gift certificate or prepaid account is not used, then the Consumer's account is verified to have the funds required to be charged, and to be in good standing in 650, if both statements are true then success is returned 660, else failure is returned 670.

The geolocation from the Consumer is determined by a geolocation-enabled cell phone or handheld device, or manual updated via a webpage or an automated update. The Vendor/Service-Provider's location is determined by the Point-of-Sale, POS, device or manual updated via a webpage or an automated update.

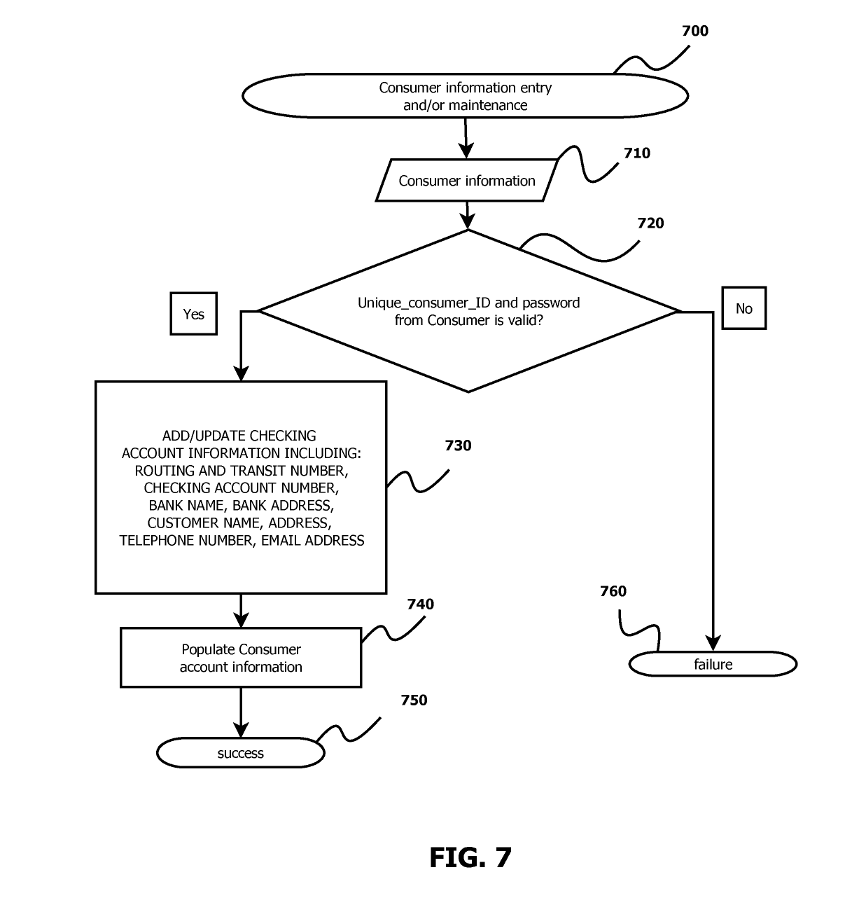

FIG. 7 is a diagram of a method for performing Consumer information entry and/or management operations 700 in a manner consistent with the presented invention. The method accepts authorized and/or authenticated Consumer input 710. The Unique_consumer_ID and time-synchronized one time password is determined to be valid in 720. Upon approval from 720 information is updated 730. Next the Consumer information is updated 740. Upon successful update the process returns a success 750. If the Unique_consumer_ID and password is not valid, the process returns failure 760.

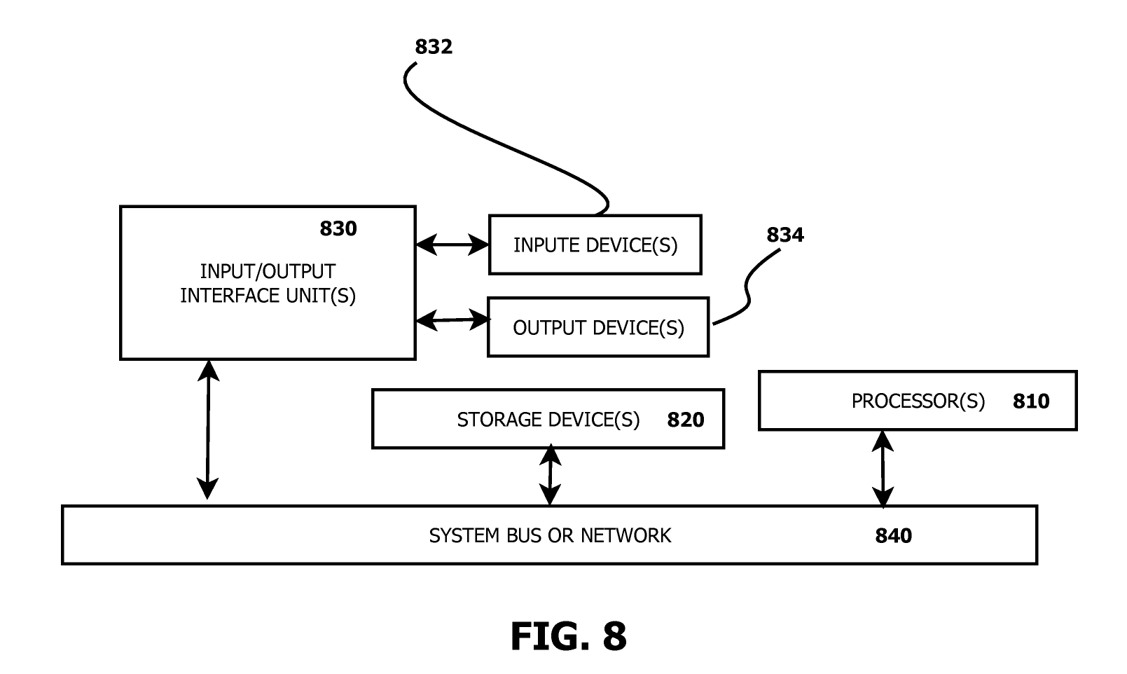

FIG. 8 is a high level diagram of a machine that may perform one or more of the operations discussed above. The invention requires the use of a machine to store data, accept inputs from the user (Consumer or Vendor/Service-Provider), output data to a human readable display, and connect to servers (other machines) over the Internet. The servers have the same requirements as the previously describe machine except the inputs, outputs, and displays are provided through a network connection and the input/output is performed on another machine connected to the network. The machine may be a personal computer, cell phone, or any machine capable of accessing a server and which includes one or more processors 810, storage devices 820, one or more input/output interface unites 830, and one or more system buses and/or networks 840 for facilitating the communication of information among the coupled elements. The machine must also contain one or more input devices 832 and one or more output devices 834 that may be coupled with the one or more input/output interfaces 830. The output devices 834 may include a monitor or cell phone display screen or other type of display device, which may also be connected to the system bus 840 via an appropriate interface. The processors 810, may execute any number of possible operating systems, including but not limited to Linux, Solaris, Windows-based, Android, iOS, webOS, and any other operating system capable of supporting a web-browser either on a cell phone, personal computer, server, or web-enabled television.

FIG. 9 provides exemplary consumer information found in item 243′ in FIG. 3, which is consistent with the presented invention.

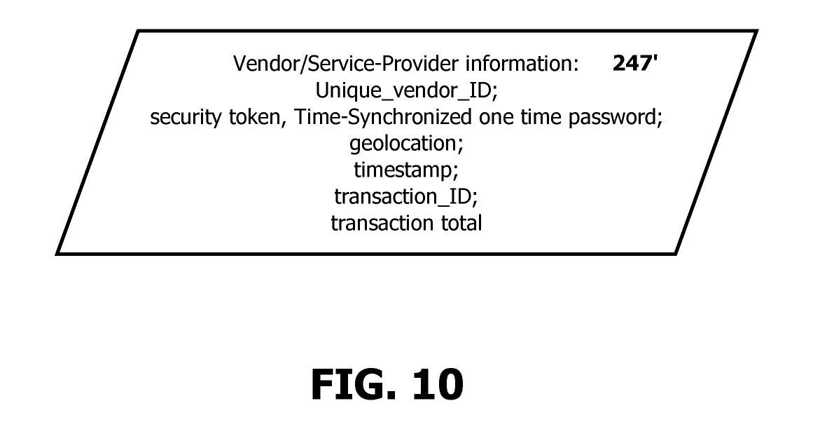

FIG. 10 provides exemplary Service Provider information stored in item 247′ in FIG. 3, which is consistent with the presented invention.

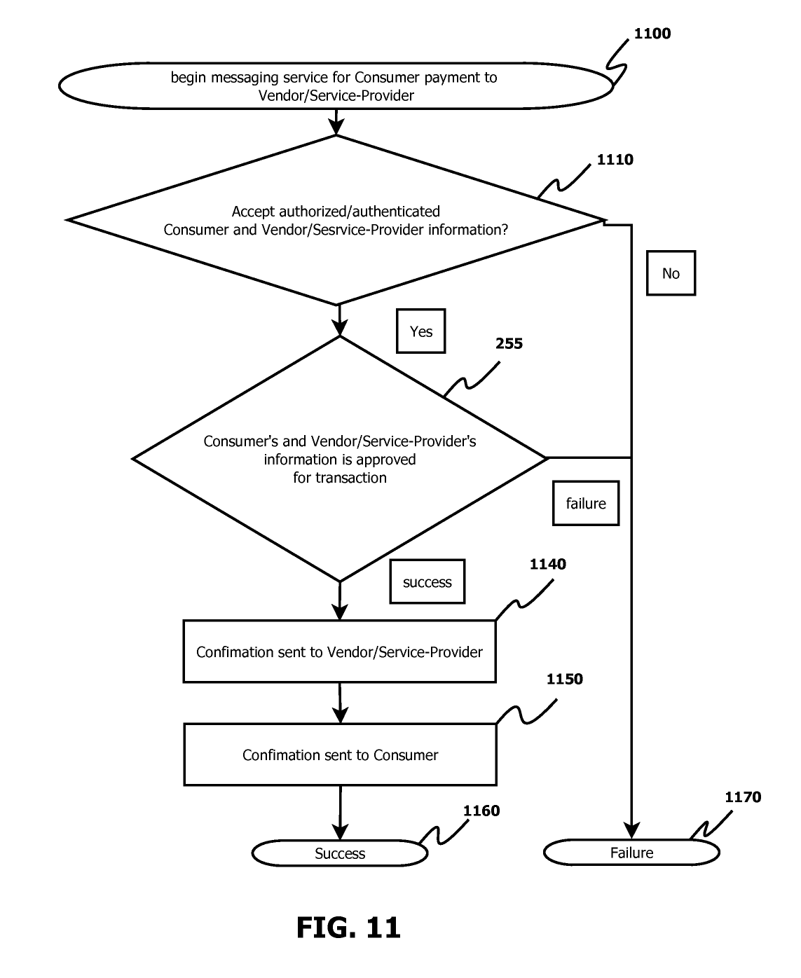

FIG. 11 is a diagram of a method for performing messaging and approval for Consumer and Vendor/Service-Provider information entry and/or management operations in a manner consistent with the presented invention. First the messaging service begins 1100. Next the time-synchronized one time password and Unique_consumer_ID and Unique_vendor_ID are verified 1110. If the answer is true then the information FIG. 3 247′ and FIG. 3 243′ is passed to the transaction approval steps 255, else failure is returned 1170. If the transaction is a success than a confirmation is sent to both the Vendor/Service-Provider 1140 and the Consumer 1150, else failure is returned 1170. After both confirmation communications are sent success is returned 1160.

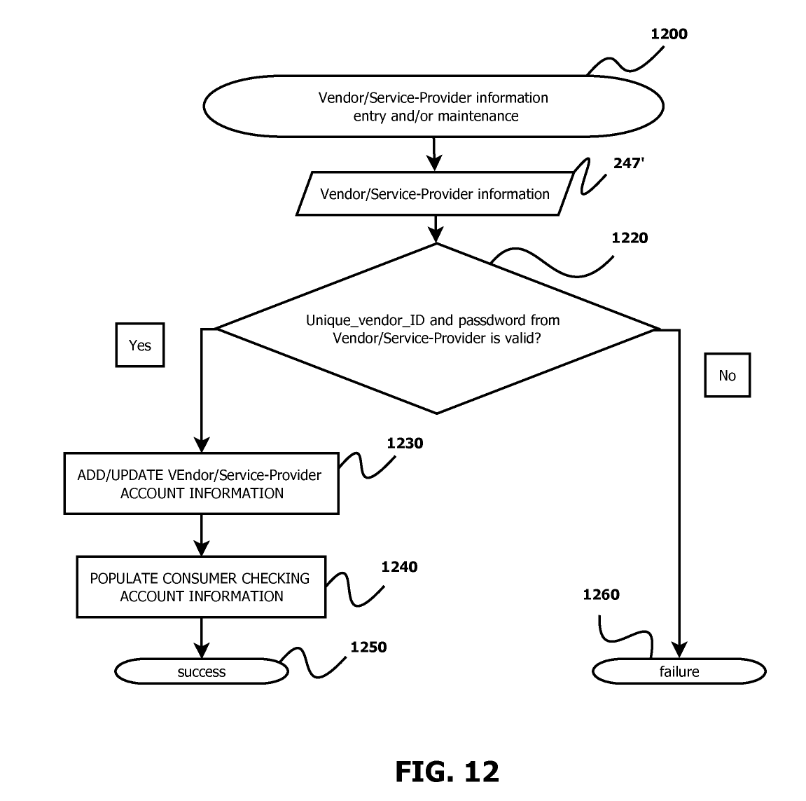

FIG. 12 is a high level diagram of a Consumer payment to Vendor/Service-Provider method and process environment. The environment may include a Vendor/Service-Provider entry system, a Service-Provider maintenance system. Service-Providers 1200 may directly, or indirectly, enter, maintain, and track Service-Provider information 247′. If credentials are valid as determined by the validation step 1220, then information may be updated in 1230, else the system returns failure 1260. Next information is populated 1240, and the process returns success 1250.

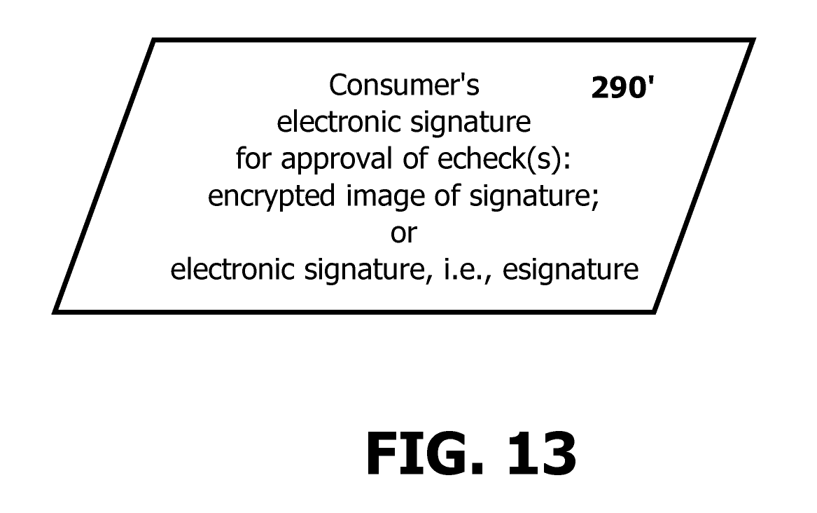

FIG. 13 provides exemplary Consumer's electronic signature information stored in item 290′ in FIG. 2, which that is consistent with the presented invention.

FIG. 14 provides exemplary Consumer information stored in item 257′ in FIG. 2 on a third party data store 350, which is consistent with the presented invention.

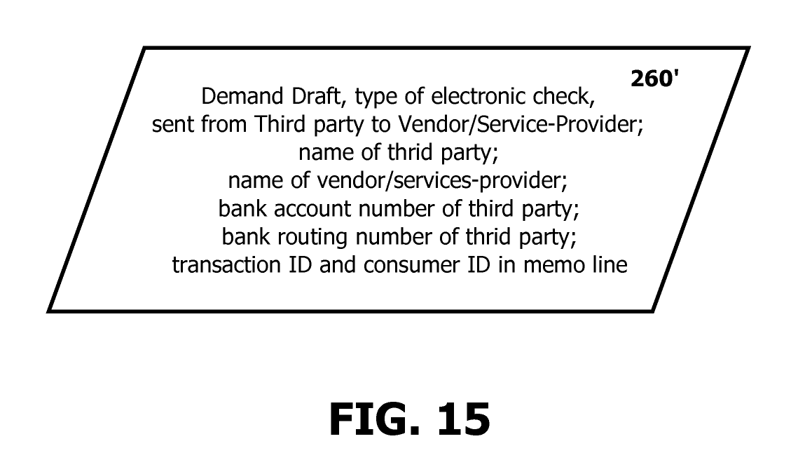

FIG. 15 provides exemplary demand draft, a type of electronic check, information sent to a Vendor/Service-Provider, including but not limited to the name of the consumer, bank account number of Consumer, and bank account routing number of consumer information stored in item 260′ in FIG. 2 on a third party data store 350, which is consistent with the presented invention.

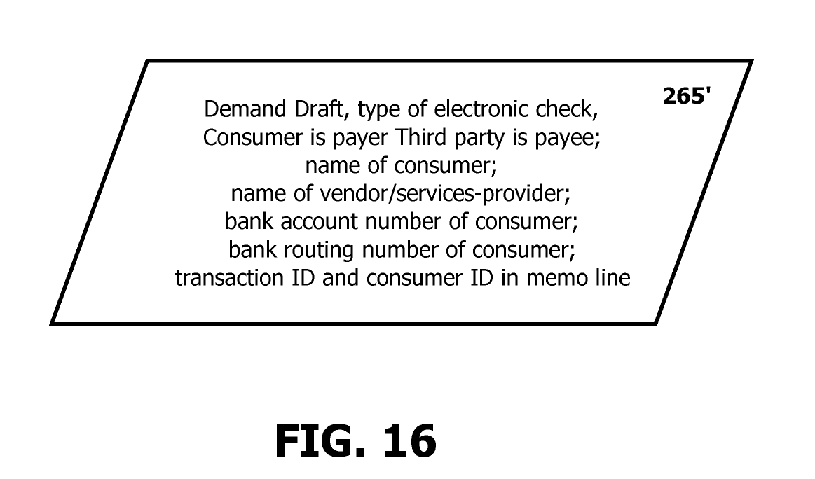

FIG. 16 provides exemplary demand draft, a type of electronic check, with the Consumer as the payer and the Third party as the payee, the information in the demand draft includes but is not limit to the name of the consumer, bank account number of Consumer, and bank account routing number of consumer information stored in item 265′ in FIG. 2 on a third party data store 350, which is consistent with the presented invention.

What is claimed is:

1. A computer-implemented method for enabling payment from a Consumer, via a third party intermediary using demand drafts and/or electronic delivery of funds, to a Vendor or Service-Provider and the method comprising:
accepting, by a computer system or cell phone or handheld device, geolocation information associated with the request;
comparing, by the computer system, the geolocation information associated with the payment from a Consumer, with geolocation information to a Vendor or Service Providers;
determining, by the computer system, whether the Consumer during the time of purchase is within the acceptable radius the Vendor's or Service-Provider's geolocation;
determining, by the computer system, whether the Consumer, during the time of purchase, has provided a valid time-synchronized one-time use password that has been generated by the hand held device;
determining, by the computer system, whether the Consumer, during the time of purchase, is in good standing with a third party before a demand draft is created or delivered;
determining, by the computer system, whether the Consumer, during the time of purchase, has funds available for a purchase in an account accessible via a unique Identification number, ID, before a demand draft is created or delivered; and
determining, by the computer system, whether the gift card holder/consumer, during the time of purchase, has funds available for a purchase in a gift card account accessible via a unique identification number, before a demand draft is created or delivered;

2. The method of claim 1 wherein the area includes a circular area of radius around a specified geographic reference point.

3. The apparatus of claim 1 wherein a demand draft from a third party is created and sent on behalf of the Consumer to a Vendor or Service Provider.

4. Apparatus for validating payment from a Consumer to a Vendor or Service-Provider process, the apparatus comprising:
at least one processor; and
at least one storage device storing processor-executable instructions which, when executed by at least one processor, perform a method of:
accepting geolocation information associated with the request;
comparing the geolocation Consumer information associated with the payment with geolocation information associated with the Vendor or Services Provider;
determining whether a time-synchronized one-time use password generated by software on a handheld device is valid;
determining whether a unique ID of a Consumer and Vendor or Service Provider is valid;
wherein the geolocation associated with the Consumer and Vendor or Service Provider corresponds to an area within close proximity.

5. The apparatus of claim 4 wherein the geolocation verification step includes a check that both parties in a payment process are within a predetermined distance to each other; with the means to determine the Consumer's or Service-Provider's location is via a cell phone and may include but is not limited to GPS, IP-addressed based locating method, cell-phone radio tower triangulation, or any other means available on a personal computer or cell phone (or any web-enabled device) for determining a Consumer's or Service-Provider's location, or a manual entry of the users' location.

6. The apparatus of claim 4 wherein the unique IDs of the Consumer is encoded within the Quick Response, QR, code.

7. The apparatus of claim 4 wherein the geolocation of the Consumer is encoded within the QR code.

8. The apparatus of claim 4 wherein the time-synchronized one-time use password of the Consumer is encoded within the QR code.

9. The apparatus of claim 4 wherein the information encoded within the QR code in encrypted.

10. The apparatus of claim 4 wherein a demand draft from a third party is created and sent on behalf of the Consumer to a Vendor or Service Provider.

11. The apparatus of claim 4 wherein the Consumer is provided a list of Service-Providers that is displayed and superimposed on a map, corresponding to the Service-Provider's location, on a web-enabled cell-phone, personal computer, or any web-enabled device with a human readable display.

12. The apparatus of claim 4 wherein the unique IDs of the Consumer is encoded within a Near Field Communication, NFC, chip.

13. A computer-implemented method for controlling serving of a Consumer to Vendor or Service-Provider payment system, via a third party intermediary using demand drafts and/or electronic delivery of funds, and the method comprising:
accepting, by a computer system or mobile device or cell phone, geolocation information associated with the request;
comparing, by the computer system, the accepted geolocation information associated with the payment;
determining, by the computer system, the validity of the payment from the Consumer to the Service-Providers based on the location of the Consumer and Service-Provider;
controlling, by the computer system, the serving of the Consumer's payment and geolocation-based information, for delivery/rendering on a client device, using the determined validity of the payment;
determining, by the computer system, whether the Consumer's geolocation at the time of payment is within the acceptable radius of the Vendor's or Service-Provider's area of service;
determining, by the computer system, whether the Consumer, during the time of purchase, has provided a valid time-synchronized one-time uses password that has been generated by the hand held device;
determining, by the computer system, whether the Consumer, during the time of purchase, is in good standing with a third party before a demand draft is created or delivered or funds are wired electronically;
determining, by the computer system, whether the Consumer, during the time of purchase, has funds available for a purchase in an account accessible via a unique identification number, before a demand draft is created or delivered;
determining, by the computer system, whether the gift card holder, during the time of purchase, has funds available for a purchase in a gift card account accessible via a unique identification number, before a demand draft is created or delivered or funds are wired electronically;
if it is determined that the Vendor or Service-Providers returned the unique ID of both Consumer's, Vendor's, and Service Provider's are validated, and the status of the Consumer as well as the funds available if a prepaid account or gift card is used;

14. A computer-implemented method for controlling serving of a Consumer to Service-Provider payment system and the method comprising:
determining, by the computer system, whether the Consumer, during the time of purchase, has provided a valid time-synchronized one-time use password that has been generated by the hand held device;
accepting, by a computer system or mobile device or cell phone, geolocation information associated with the request;
comparing, by the computer system, the accepted geolocation information associated with the payment;
determining, by the computer system, the validity of the payment from the Consumer to the Service-Providers based on the location of the Consumer and Service-Provider;
